(19) United States
(12) Patent Application Publication
(10) Pub. No.: US 2012/0044292 A1
(43) Pub. Date: Feb. 23, 2012

(54) Vacuum Control For Print Head of A Printing System

(75) Inventors: Bradley Helsel, Rindge, NH (US); Jason Dean, Swanzey, NH (US); Mark Noyes, Keene, NH (US)

(73) Assignee: MARKEM-IMAJE CORPORATION, Keene, NH (US)

(21) Appl. No.: 12/858,307

(22) Filed: Aug. 17, 2010

(51) Int. Cl. B41J 29/38

(52) U.S. Cl. 347/14

(57) ABSTRACT

According to an aspect of the disclosed subject matter, a controller to maintain negative pressure in a print head of a printing system includes: control loop feedback logic to receive a set point and an output of a vacuum sensor associated with the print head; a regulator coupled with an output of the feedback logic; and a driver coupled with the regulator and configured to output a drive signal to a pump, which is associated with the print head, responsive to an output of the regulator. According to another aspect of the disclosed subject matter, a vacuum control assembly for a printing system includes: a body having one or more associated accumulators; a pump coupled with the body; and one or more flexible tubes coupled with the one or more accumulators associated with the body and configured to restrict air flow within the vacuum control assembly.

### BACKGROUND

This disclosure relates to printing systems, and in particular, to ink jet printing systems.

Ink jet printing systems include a print head having small orifices through which ink is ejected in a controlled manner to form an image on an adjacent substrate. To counteract the effect of capillary action in the small orifices which would otherwise cause ink to seep out of the print head when not in use but, at the same time, prevent air from being drawn into the print head through the orifices, the ink in the print head must be maintained at a selected negative pressure which is dependent upon the orifice size and the ink characteristics. In ink jet printing systems having a remote ink supply connected to the print head through a supply line, however, the pressure of the ink in the print head can be affected by the relative vertical positions of the print head and the remote ink supply. Moreover, some ink jet printing systems are designed to operate with multiple available orientations of the print head, which can also affect the pressure of the ink in the print head.

### SUMMARY

This disclosure describes systems and techniques to set and maintain desired pressure values in print heads of ink jet printing systems. According to an aspect of the disclosed subject matter, a controller to maintain negative pressure in a print head of a printing system includes: control loop feedback logic to receive a set point and an output of a vacuum sensor associated with the print head; a regulator coupled with an output of the feedback logic; and a driver coupled with the regulator and configured to output a drive signal to a pump, which is associated with the print head, responsive to an output of the regulator. The regulator can include a voltage regulator, and the control loop feedback logic can include proportional-integral-derivative (PID) circuitry. The driver can include: a programmable logic device (PLD) to generate a pulse width modulated (PWM) signal; and integrated circuitry coupled with the PLD to modulate the PWM signal, responsive to a motor drive voltage output of the voltage regulator, to generate the drive signal.

The PID circuitry can include a closed loop circuit including exactly six operational amplifiers. The PLD can be configured to generate a sixty hertz square wave pulse. In addition, the controller can include a processor programmed to establish the set point by performing operations including: ramping, at initialization, the set point to a value selected to maintain a negative pressure at a desired level; maintaining, at run time, the set point at a constant value; replacing, during a purge cycle, the negative pressure with a positive pressure using a set point change; and ramping, after the purge cycle, the set point back to the value selected to maintain the negative pressure at the desired level.

According to another aspect of the disclosed subject matter, a vacuum control assembly for a printing system includes: a body having one or more associated accumulators; a pump coupled with the body; and one or more flexible tubes coupled with the one or more accumulators associated with the body and configured to restrict air flow within the vacuum control assembly. The one or more flexible tubes can include Polyvinyl Chloride (PVC) microbore tubing manufactured for medical and laboratory environments. The one or more flexible tubes can include multiple, fixed diameter tubes having tube lengths selected to produce target amounts of air flow restriction. In addition, the body can include a machined plate structure that forms the one or more associated accumulators therein.

According to another aspect of the disclosed subject matter, a hot melt ink jet printing system includes: a jetting assembly having at least one ink reservoir; a vacuum sensor associated with the at least one ink reservoir of the jetting assembly; a vacuum control assembly coupled with the at least one ink reservoir of the jetting assembly, the vacuum control assembly including a pump; and a controller coupled with the vacuum control assembly to maintain a negative pressure in the at least one ink reservoir of the jetting assembly; wherein the controller includes: control loop feedback logic to receive a set point and an output of the vacuum sensor, a regulator coupled with an output of the feedback logic, and a driver coupled with the regulator and configured to output a drive signal to the pump responsive to an output of the regulator.

The regulator can include a voltage regulator, and the control loop feedback logic can include proportional-integral-derivative (PID) circuitry. The driver can include: a programmable logic device (PLD) to generate a pulse width modulated (PWM) signal; and integrated circuitry coupled with the PLD to modulate the PWM signal, responsive to a motor drive voltage output of the voltage regulator, to generate the drive signal. The PID circuitry can include a closed loop circuit including exactly six operational amplifiers, the PLD can be configured to generate a sixty hertz square wave pulse, and the controller can include means for establishing the set point by performing a ramping process.

The vacuum control assembly can include: a body coupled with the pump and having one or more associated accumulators; and one or more flexible tubes coupled with the one or more accumulators associated with the body and configured to restrict air flow within the vacuum control assembly. The one or more flexible tubes can include Polyvinyl Chloride (PVC) microbore tubing manufactured for medical and laboratory environments. The one or more flexible tubes can include multiple, fixed diameter tubes having tube lengths selected to produce target amounts of air flow restriction. Moreover, the body can include a machined plate structure that forms the one or more associated accumulators therein.

The systems and techniques described herein may provide several advantages. A low vacuum negative pressure can be maintained in the print head at a lower cost than solutions employed currently, while improving yield and performance in the field. The accuracy of the vacuum pressure can be improved, making it less susceptible to changes when filling the print head reservoir. Using proportional-integral-derivative (PID) logic implemented using analog componentry can provide 100% linearity in the control signal for the vacuum pressure, which can result in very high accuracy of control. Moreover, variations from a defined set point can be minimized, which can reduce air ingestion issues, since overshooting the set point can cause air ingestion in the print head. Minimizing air ingestion can also minimize jet instability.

Another attribute of the voltage control scheme described herein is that a greater vacuum range can be achieved, allowing for improved operation in high altitude applications by pulling lower vacuums than previously done. Using the PID circuit design described herein also allows for more accurate detection of high vacuum line irregularities and consequently reduced fluctuation in low vacuum levels. The low vacuum level typically fluctuates by only 5-7% in implementations of the present invention, allowing the system to differentiate between a low vacuum leak and high vacuum leak. With previous system, low vacuum could fluctuate as much as 30% during an extreme high vacuum leak, which could result in inaccurate faults being generated by software. Moreover, using the tubing in the described implementations can facilitate adaptability to future design changes, such as changes in the pump, jetting assembly, assembly requirements, etc.

Details of one or more implementations are set forth in the accompanying drawings and the description below. Other features and advantages may be apparent from the description and drawings, and from the claims.

### BRIEF DESCRIPTION OF THE DRAWINGS

FIG. 1A shows an example of an ink jet printer system in association with a product packaging line.

FIG. 1B shows an example of a print head used in the system of FIG. 1A.

FIG. 1C shows a rear view of the print head shown in FIG. 1B positioned vertically for horizontal ejection of ink with the orifice array oriented in a horizontal line.

FIG. 1D shows a rear view of the print head shown in FIG. 1B positioned in a sidewise orientation for horizontal ejection of ink with the orifice array oriented in a vertical line.

FIG. 1E shows a side view of the print head shown in FIG. 1B positioned horizontally for downward ejection of ink from the orifices.

FIG. 2 shows another example of an ink jet printer system.

FIG. 3A shows an example of a controller that maintains negative pressure in a print head.

FIG. 3B shows an example of a PID circuit that can be used in the controller of FIG. 3A.

FIG. 4A shows an example of a processor implementation of defined set point, ramp, and digital to analog converter elements from the controller of FIG. 3A.

FIG. 4B shows the output from the microprocessor of FIG. 4A in accordance with the defined set point.

FIG. 4C shows an example of a ramping process to establish the set point.

FIG. 5 is a schematic diagram showing an example of a vacuum purge control assembly for a printing system.

FIG. 6A is a top view showing an example of an implementation of the vacuum purge control assembly of FIG. 5.

FIG. 6B is a bottom view showing the example of the vacuum purge control assembly from FIG. 6A.

FIG. 6C is an exploded bottom view showing the example of the vacuum purge control assembly from FIG. 6A.

FIG. 6D is an exploded top view showing the example of the vacuum purge control assembly from FIG. 6A.

Like reference characters in the various drawings indicate like elements.

### DETAILED DESCRIPTION

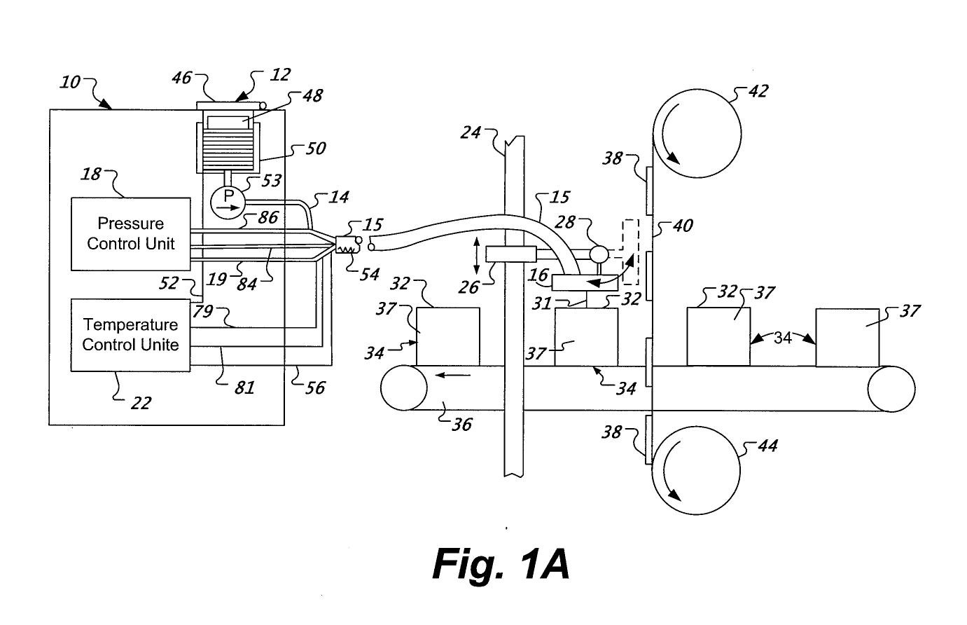

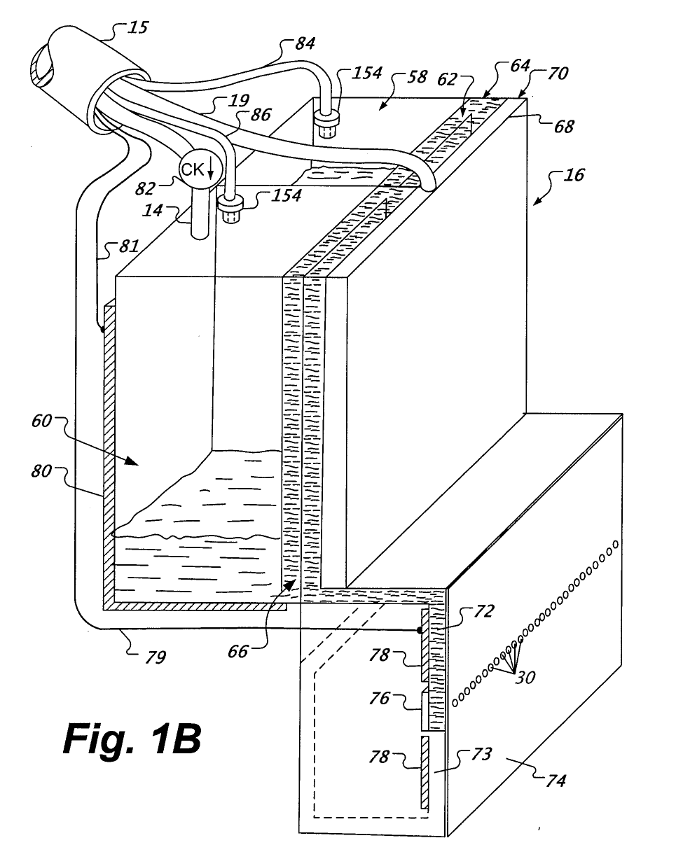

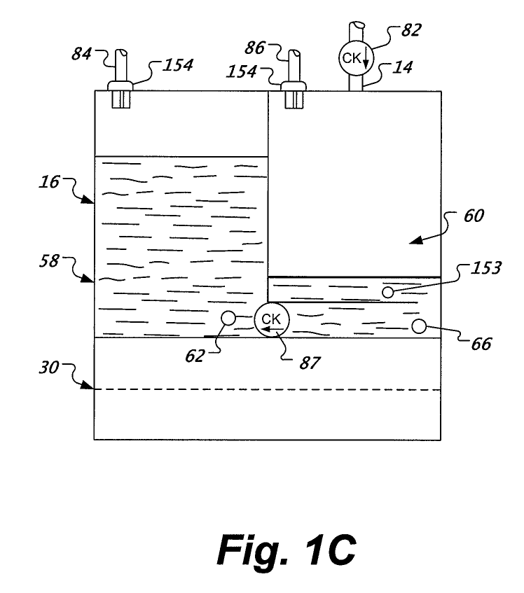

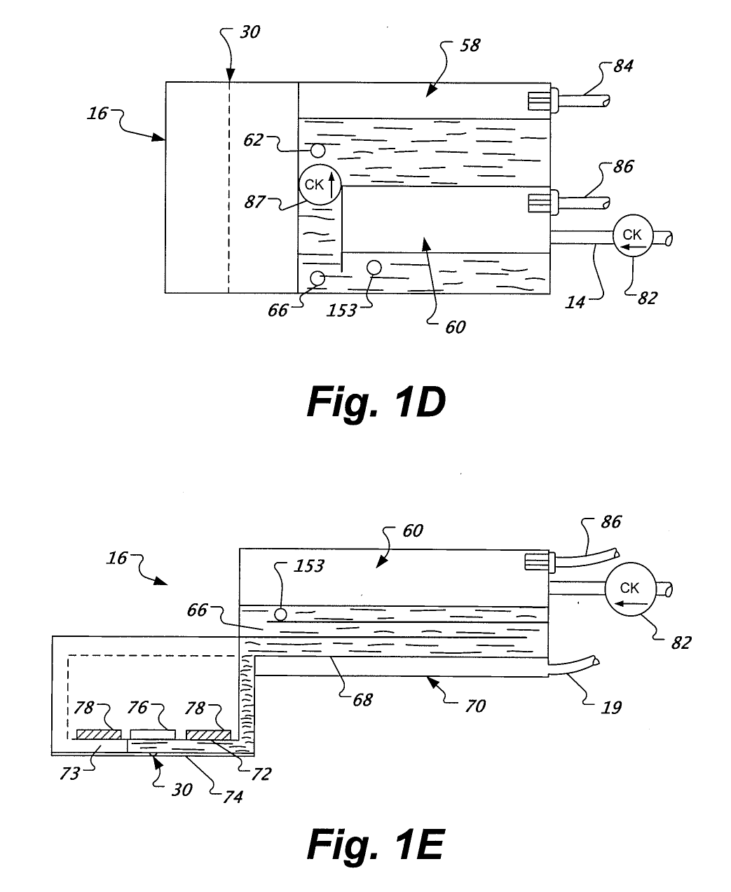

FIG. 1A shows an example of an ink jet printer system in association with a product packaging line. In this example, a main control unit 10 includes a remote ink supply reservoir 12 connected through an ink supply conduit 14 in a cable 15 to an ink jet print head 16 and a pressure control unit 18 connected to the ink jet print head 16 through three air conduits 19, 84 and 86, also carried by the cable 15. In addition, the main control unit 10 includes a temperature control unit 22 for controlling the temperature of hot melt ink in various portions of the ink jet system.

To facilitate positioning of the print head 16 adjacent to different types of objects to which printing is to be applied, the print head 16 can be movably supported on a vertically disposed column 24 so as to be locked by a clamp 26 at any desired vertical position on the column. In addition, the print head 16 can be supported for pivotal motion in any vertical plane by a clampable universal joint 28 so that the print head can be oriented to permit a linear array of ink jet orifices 30 therein (as shown in FIG. 1B) to project ink horizontally, either in a horizontal line or in a vertical line, or downwardly.

In the arrangement shown in FIG. 1A, the print head 16 is disposed in a horizontal orientation (as shown in solid lines) to cause the print head orifices 30 (shown in FIG. 1B) to project a train of ink drops 31 downwardly onto the top surfaces 32 of a series of containers 34 which are conveyed in the horizontal direction by a conveyor 36, thus permitting appropriate information to be printed on the top surface of each of the containers. If desired, the print head 16 can be lowered on the column 24 and the universal joint 28 can be arranged to clamp the head 16 in a sidewise orientation with the array of orifices 30 extending vertically and facing the near sides 37 of the containers 34, as viewed in the drawing, so as to cause information to be printed on the sides of each of the containers as they are conveyed past the print head by the conveyor 36.

In still another print head position, the printing can be arranged to print a series of labels 38 conveyed on a tape 40 in a vertical direction from one reel 42 to another reel 44 by adjusting the universal joint 28 to clamp the print head in a vertical orientation (as shown in dotted outline in FIG. 1A) so that the array of orifices 30 extends horizontally and faces the labels 38 as they are conveyed in the vertical direction.

The ink supply reservoir 12 in the main control unit 10 which has a sealing cover 46; is arranged to receive a block 48 of solid hot melt ink and has a thermostatically controlled heater 50 connected by a line 52 to the temperature control unit 22. The temperature control unit 22 is arranged to control the heater 50 so as to heat the block of hot melt ink 48 sufficiently to melt it and to maintain the ink in the supply reservoir 12 at a temperature just above its melting point so that it is sufficiently liquid that it can be transferred by a pump 53 through the supply conduit 14 to the print head 16 as required. At the same time, the ink temperature in the supply reservoir 12 is kept low enough so that no appreciable degradation will take place even though the ink is maintained continuously at that temperature for several days or weeks. Similarly, the ink supply conduit 14 contains a thermostatically controlled heater 54 connected through a line 56 to the temperature control unit 22 so that the ink in the supply line is also maintained continuously in liquid condition, but at a temperature low enough that no appreciable degradation occurs.

As shown in FIGS. 1B-1E, the print head 16 includes two ink reservoirs 58 and 60 containing ink at different levels, a passage 62 leading from the high level reservoir 58 to a deaerator 64 and another passage 66 leading from the low level reservoir to the deaerator 64. The passages 62 and 66 pass downwardly as viewed in FIGS. 1B and 1C in the deaerator 64 adjacent to a membrane 68, which separates those passages from a vacuum chamber 70 connected to the vacuum line 19 from the pressure control unit 18. That line and the chamber 70 can be maintained at a pressure level of about 25 inchesHg to extract dissolved air from the ink passing through the passages 64 and 66 adjacent to the membrane 68. After passing through the deaerator 64, the ink passages 62 and 66 extend downwardly to supply alternately adjacent orifices 30 respectively in the array, ink from the low level reservoir being supplied through a passage 72 shown in FIG. 1B which extends downwardly adjacent to an orifice plate 74 to supply alternate odd-numbered orifices in the array, and ink from the high level reservoir being supplied downwardly to the bottom of the orifice plate 74 and upwardly adjacent to the orifice plate to the alternate even-numbered orifices 30 through a passage 73 shown in dotted line in FIG. 1B.

Each of the orifices 30 in the print head 16 has an associated transducer 76 arranged to respond to electrical signals to eject ink drops through the corresponding orifice in the usual manner, as described, for example, in the Fischbeck et al. U.S. Pat. No. 4,584,590. An appropriate arrangement of the ink passages 72 and 73, transducers 76, orifices 30 and supply passages 62 and 66 is described in detail in the Hoisington et al. U.S. Pat. No. 4,835,554.

In order to maintain the ink in the orifice passages 72 and 73 at the temperature required for jetting through the orifices 30, a heater 78 is mounted in the print head adjacent to the passages 72 and 73 and is connected through a line 79 in the cable 15 to the temperature control unit 22. In addition, a further heater 80 is mounted adjacent to the reservoirs 58 and 60 and is connected to the control unit 22 by a line 81. The control unit is arranged to maintain the temperature of the ink in the reservoirs 58 and 60 at a temperature sufficiently below the jetting temperature to avoid degradation, but close enough to the jetting temperature to permit the orifice passage heater 78 to heat the ink quickly to the jetting temperature as the ink is supplied through the passages 72 and 73 to the orifices 30.

As an example, for a hot melt ink which has a melting point of about 90° C. and tends to degrade when maintained for substantial periods of time at temperatures above 130° C., the temperature control unit 22 can be arranged to maintain the temperature of the ink in the remote ink supply reservoir 12 and in the ink supply conduit 14 at a temperature of about 100° C. and to control the heater 80 to maintain the ink in the reservoirs 58 and 60 at a temperature of about 125° C., but to control the heater 78 so as to maintain the ink in the passages 72 and 73 leading to the orifices 30 at a jetting temperature of 137° C. Since only a small quantity of ink is maintained in the passages 72 and 73 and, during operation, the ink passes through those passages relatively rapidly, no significant degradation of ink can occur during operation of the ink jet system.

When the ink jet system is not in use, but is being maintained ready for use as, for example, during the course of a working day in which the system is used only periodically, the temperature control unit 22 reduces the temperature of the ink in the passages 72 and 73 to a lower level, such as the 125° C. temperature of the ink in the reservoirs 58 and 60. Moreover, if the capacity of the reservoirs 58 and 60 is small enough to permit rapid heating of the ink in those reservoirs to the normal 125° C. operating temperature, the temperature control unit 22 can be arranged to maintain the ink in those reservoirs as well as in the orifice passageway 68 at an even lower temperature such as 120° C. when the system is in the stand-by condition.

Since the solidification of molten hot melt ink normally causes the ink to contract in volume, air can be drawn into the passages 72 and 73 when the printing system is turned off and the ink in the system solidifies, leading to start-up problems. In order to avoid such problems, the temperature control unit 22 is arranged to cause the ink in the reservoirs 58 and 60 and the deaerator 64 to be maintained in the molten condition until the ink in the passages 72 and 73 has solidified when the printing system is turned off, thereby preventing air from being drawn into those passages as the reservoir ink solidifies. In addition, the negative pressure normally applied to the reservoirs as described hereinafter can be terminated while the ink in the passages 72 and 73 is cooling to reduce the tendency of air to be drawn into the orifices 30.

In order to maintain the pressure of the ink in the orifices 30 at the desired negative pressure level during operation regardless of the elevation or orientation of the print head 16 with respect to the remote ink supply reservoir 12, the ink supply conduit 14 leading from the remote ink supply reservoir 12 to the print head can include a check valve 82 which is spring-biased toward the closed position with sufficient force to require an ink pressure of for example, at least 5 psi to open the valve and permit ink to pass from the line 14 into the low level reservoir 60. Since the check valve 82 is closed except when ink is being supplied to the reservoir 60, the relative elevation of the print head 16 with respect to the ink supply reservoir 12 will have no effect on the pressure of the ink in the reservoirs 58 and 60 and in the passages 72 and 73 leading to the orifices 30.

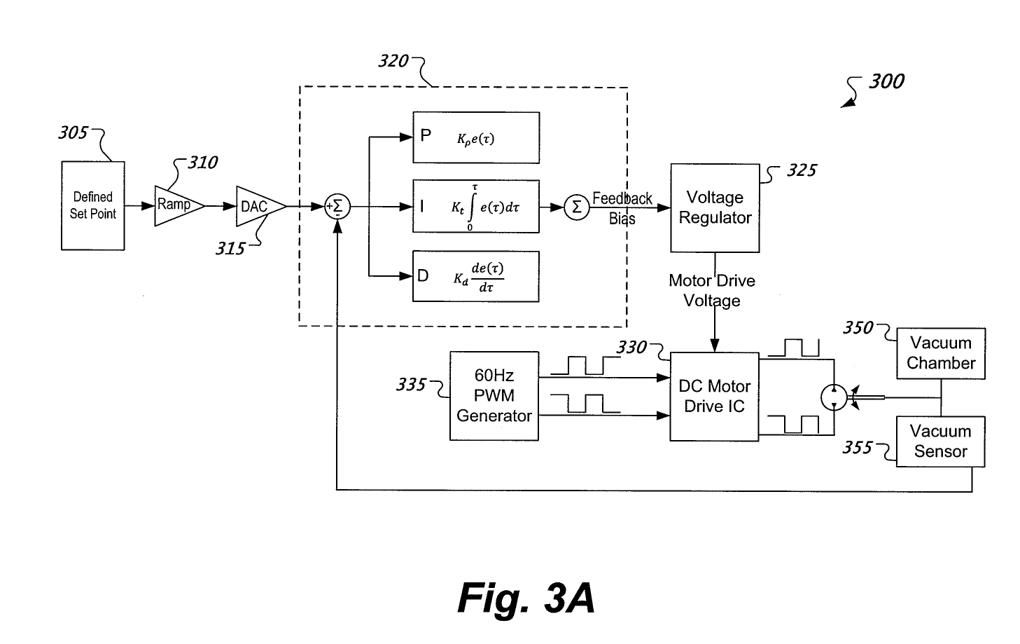

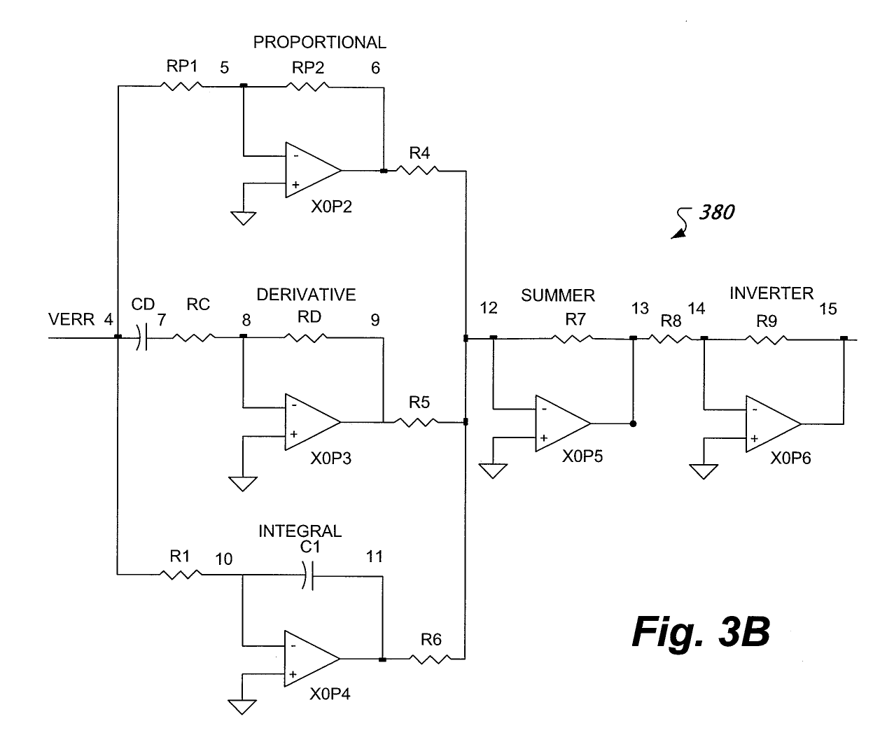

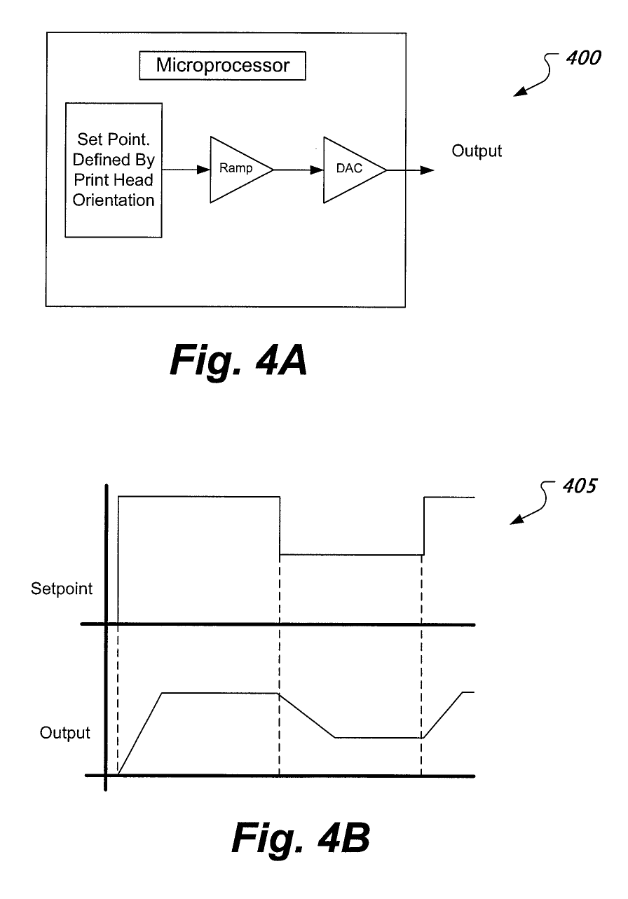

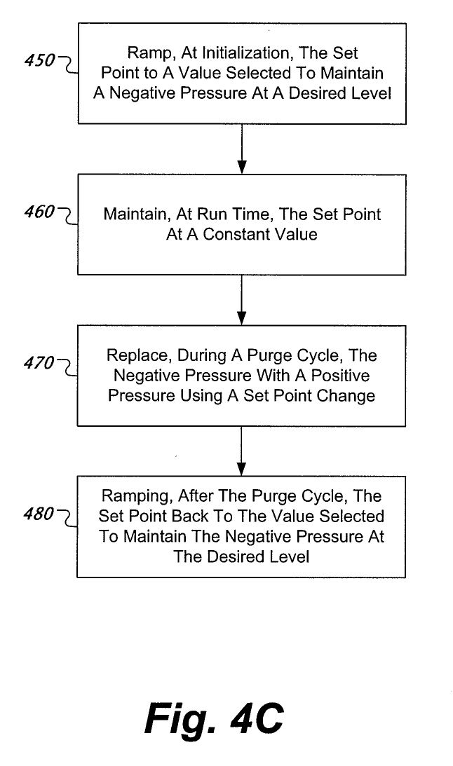

To maintain the pressure in the orifices 30 at the desired negative level during normal operation, the print head pressure control unit 18 in the main control unit 10 is connected through two conduits 84 and 86 to the reservoirs 58 and 60, respectively, so that a negative air pressure of approximately 2.8 inches of water is normally maintained in those reservoirs. With the orifice array extending in the horizontal direction slightly less than one inch below the reservoirs, as shown in FIG. 1B, this pressure level produces a negative air pressure of about two inches at the orifices 30 which is sufficient to prevent ink from seeping out of the orifices as a result of capillary action, but is not low enough to cause air to be drawn into the passages 72 and 73 through the orifices 30, which would interfere with the operation of the system. Further details regarding setting and maintaining the negative air pressure in the print head 16 are described below in connection with FIGS. 3-4C.

As also described in the Hoisington et al. U.S. Pat. No. 4,835,554, each of the ink passages 72 and 73 is connected through a return flow path (not shown) to the ink passages 62 and 66 leading to the other of the two reservoirs 58 and 60. With this arrangement, when the printer is not operating, ink is caused by the difference in the levels in the reservoirs to flow continuously at a low rate from the high level reservoir 58 to the low level reservoir 60 through the deaerator 64 in order to maintain the ink at the orifices 30 in a deaerated condition. As a result, the difference in the ink levels in the reservoirs is gradually reduced thereby reducing the pressure which causes the ink to flow through the deaerator and the associated passages leading to the orifices 30. In order to restore the difference in the ink level in the reservoirs 58 and 60, the pressure control unit 18 periodically applies a higher negative pressure of about 3.2 inches of water through the line 84 to the ink in the reservoir 58 thereby drawing ink through a check valve 87 from the low level reservoir 60 to the high level reservoir 58 until the difference in the ink levels in the reservoirs balances the applied pressure difference.

In addition, when the ink jet system is started up after being cold, for example after having been turned off overnight, it may be necessary to purge air bubbles and debris from the orifice passages 72 and 73 in order to assure proper operation of the system This is accomplished by applying a positive pressure of about 2 psi through both of the lines 84 and 86, thereby forcing ink from both reservoirs through the orifice passages 68 and out of the orifices 30 to remove any air bubbles and debris which may be trapped in those passages.

FIG. 1D shows the print head 16 oriented in a position in which the array of orifices 30 extends in the vertical direction, such as to print information on the sides of the containers 34 as described above with reference to FIG. 1A. In this case, because of the different elevations of the reservoirs 58 and 60, the ink pressure will normally be less at the orifices supplied by the low level reservoir 60 than at the orifices supplied by the high level reservoir 58, which could cause air to be drawn into the ink passages 72 receiving ink from the low level reservoir or produce seepage of ink at the orifices connected to the high level reservoir 58. In order to avoid this potential problem, the pressure control unit 18 is arranged to reduce the negative pressure applied to the high level reservoir while maintaining the desired negative pressure at the low level reservoir. For example, a negative pressure of about 1.1 inches of water can be applied through the line 86 to the low level reservoir 60 while the usual negative pressure of about 2.8 inches of water is applied through the line 84 to the high level reservoir 58, providing a difference of about 1.7 inches of water between the negative pressures applied to the reservoirs to compensate for the difference in the height of the reservoirs (as shown in FIG. 1D) when the array is oriented in the vertical direction.

FIG. 1E shows the print head when positioned to project ink downwardly from the orifices 30, for example, to the top surfaces of the containers shown in FIG. 1A. In this case, the two reservoirs are at the same elevation and the elevational difference between the reservoirs and the orifices is approximately the same as that of FIGS. 1B and 1C. Consequently, the same negative pressure of about 2.8 inches of water is applied to both reservoirs. Further details regarding the exemplary pressure control unit 18, and its interconnections with the print head 16, are described in the Brooks et al. U.S. Pat. No. 5,489,925. Nonetheless, it will be recognized that other implementations of the present invention need not include the details of the example system described above in connection with FIGS. 1A-1E.

In other implementations, the pressure control unit can have it elements separated from each other and integrated with other portions of the larger system. For example, the pressure control can be implemented using a vacuum purge control assembly and separate control electronics (e.g., on one or more circuit boards). The vacuum purge control assembly and separate control electronics can be combined together in a single unit, such as the print head itself or the main control unit 10 shown in FIG. 1A, which can also include a user interface device, a power supply, as well as other components. Alternatively, the vacuum purge control assembly and separate control electronics can be placed in separate units.

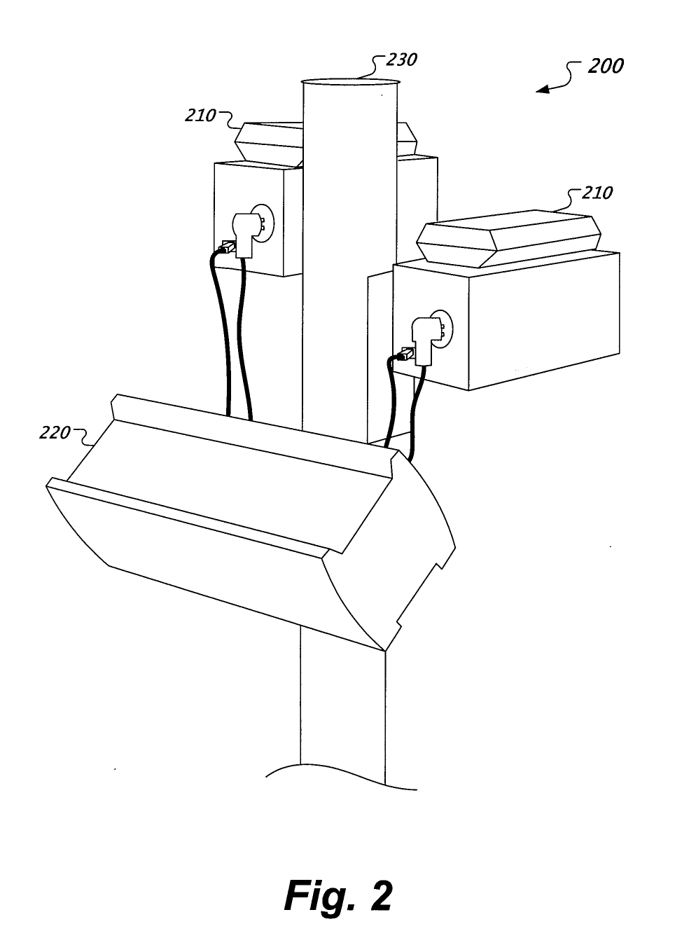

FIG. 2 shows another example 200 of an ink jet printer system. In this case, two print heads 210 are movably supported on a vertically disposed column 230 so as to be locked at any desired vertical position on the column 230. Each of the print heads 210 includes its own ink reservoir, vacuum purge control assembly, and jetting array. In addition, separate control electronics are included in a control unit 220 that is also movably supported on the vertically disposed column 230 so as to be locked at any desired vertical position on the column 230, and the control unit 220 is electrically coupled with the print heads 210 to control purging and negative pressure setting and maintenance for the ink reservoirs and jetting arrays. The control unit 220 can also include a user interface device and power supply. Thus, as will be understood, the systems and techniques described in this application can be employed with many different printing system configurations, including different numbers of ink reservoirs at different locations.

FIG. 3A shows an example of a controller 300 that maintains negative pressure in a print head. The controller 300 can receive a defined set point 305, and can include a ramp 310 and digital to analog converter (DAC) 315. The set point 305 can be defined by a user of the system, by print head orientation, or by a combination of these. Moreover, the set point 305, ramp 310, and DAC 315 can be implemented using a processor, as is described further below in connection with FIGS. 4A-4C.

The controller 300 includes control loop feedback logic 320, which can be proportional-integral-derivative (PID) logic (as shown), PI logic, PD logic, P logic, I logic, or D logic. For example, the PID logic can be a closed loop circuit 380, as shown in FIG. 3B; having six operational amplifiers. Note that if PI logic or PD logic is used instead, the number of operational amplifiers can be reduced. Other forms of control loop feedback logic 320 are also possible. For example, rather than implementing this control logic entirely in analog componentry, various implementations can employ integrated circuitry (IC), a processor, firmware, or some combination thereof.

The controller 300 includes a voltage regulator 325. The voltage regulator 325 can be a switching voltage regulator, a linear regulator, an amplifier controlled regulator, or other regulators that have an adjustable feature. The feedback logic 320 provides feedback bias to the voltage regulator 325 to control the output of the voltage regulator 325 (motor drive voltage), which is then provided to a driver configured to output a drive signal to a pump, which is associated with the print head. Thus, the amplitude of the motor drive voltage is controlled at the voltage regulator 325 to generate an appropriate drive signal for the pump and its associated vacuum chamber 350 and vacuum sensor 355.

The driver can be implemented using a direct current (DC) motor drive IC 330 and a square wave generator 335. The square wave generator 335 can be implemented using a programmable logic device (PLD) that generates a 60 Hz pulse width modulated (PWM) signal. Note that different frequencies other than 60 Hz may be needed for implementations using different types of pumps. In addition, rather than the motor drive IC 330, field-effect transistors (such as MOSFETs or JFETs) on an electronics board can be used, provided they have the current and voltage capabilities needed for a given implementation.

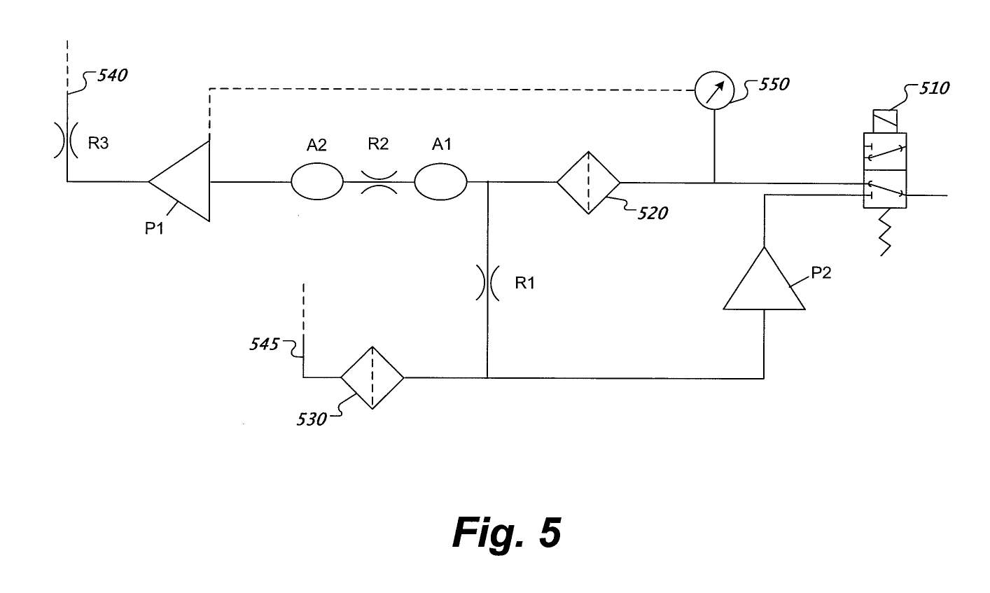

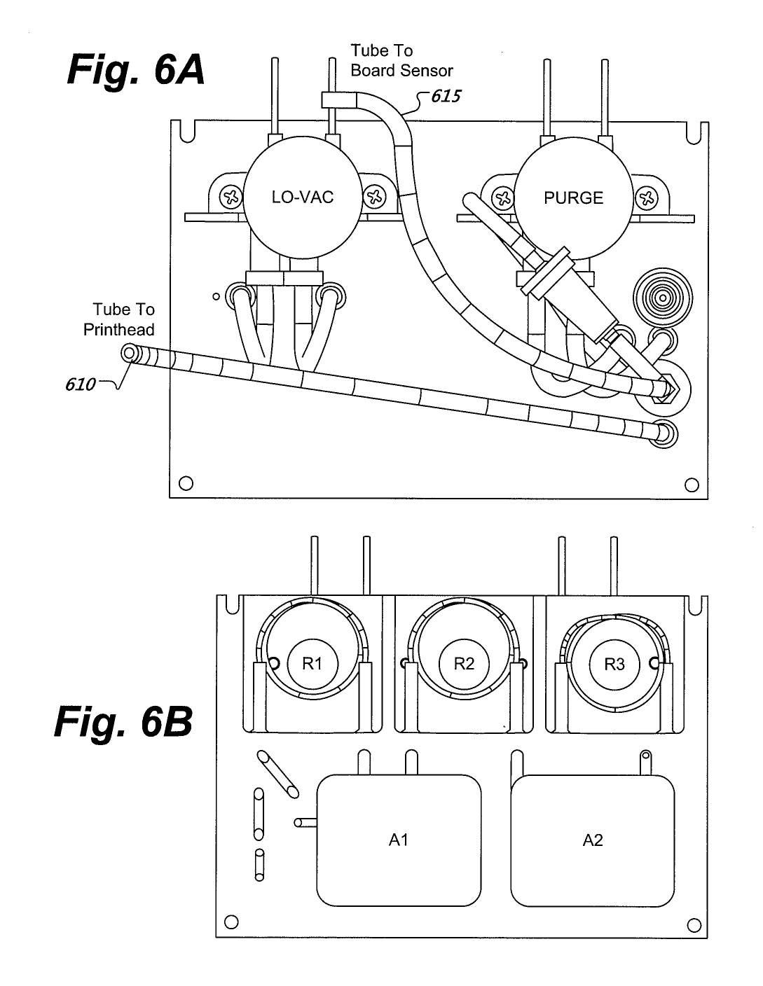

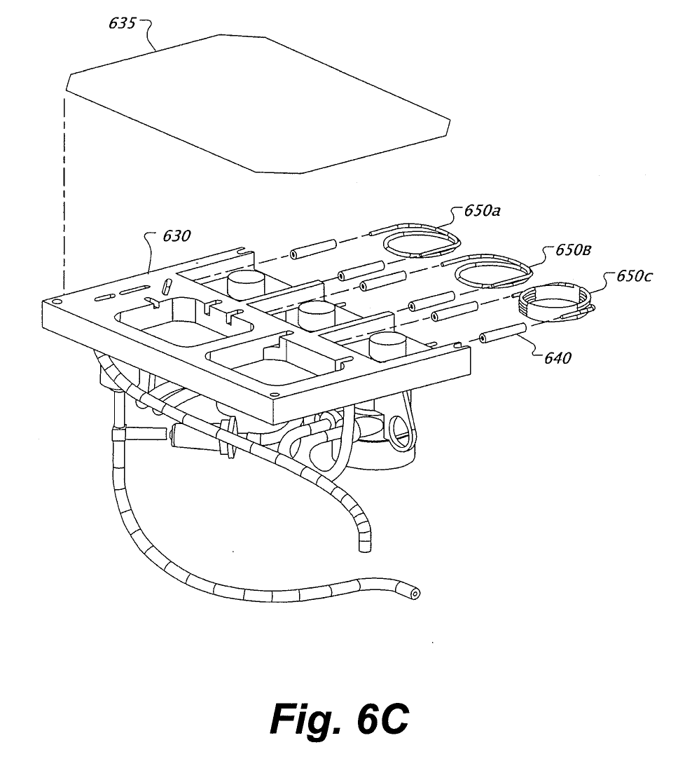

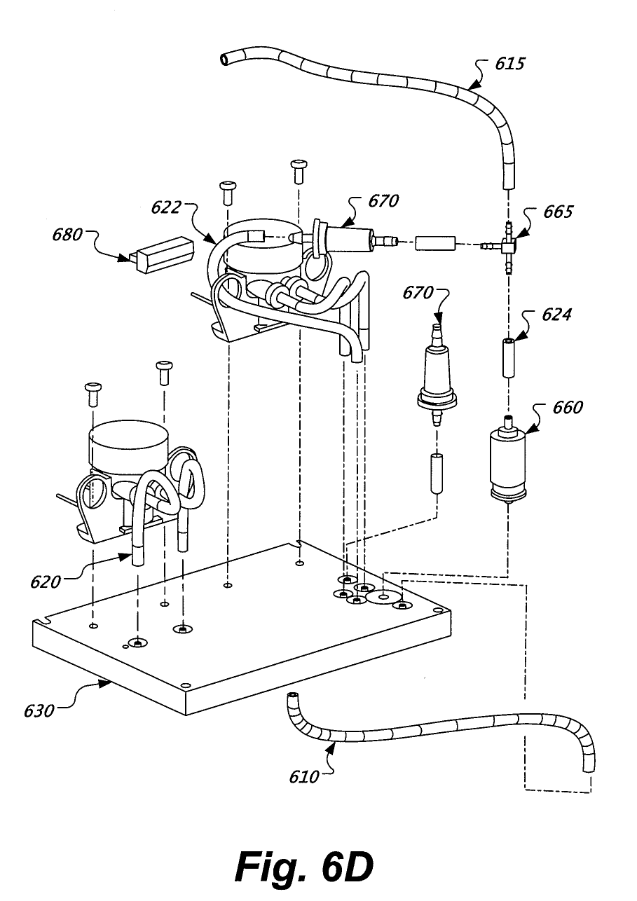

The drive signal can be a 50% duty cycle 60 Hz square wave, with the voltage being adjusted based on a variable but algorithmically determined vacuum set point. Voltage control can provide smoother operation (quicker to the set point and more uniform vacuum control) which can provide more consistent and uniform meniscus properties and may provide longer pump life. The voltage control circuit can also provide a smoother pump output throughout its range. This is due in part to keeping the drive frequency and phase constant. This in turn, gives the oscillations of the pump diaphragm the ability to stay in a tightly matched synchronous pattern. This is in contrast with previous PWM circuits, where the frequency and voltage were constant, and the phase was altered to adjust pump output. At various points across its drive range, the existing PWM circuit/algorithm can cause the diaphragm to become out of synch and unstable. This is most often noticeable at the upper ends of the output scale. In addition, in order for the low vacuum circuit to operate with the types of pumps typically used in industrial printing systems, a method of restricting air flow to the pump can be provided, as described further below in connection with FIGS. 5-6D.

A PID circuit can be used to establish a set point via a processor based on the appropriate vacuum level for the print head jetting orientation, which can be selected from a user interface or automatically determined The low vacuum sensor output can be used as the feedback loop and adjusting the feedback loop, based on the set point, can be accomplished by biasing the switching regulator's feedback loop, which adjusts the output voltage amplitude. The output amplitude determines the force at which the pump is driven to generate the low vacuum level. Properly tuned, the PID circuit can provide a feedback bias that will result in a steady output voltage amplitude to drive the low vacuum pump.

The use of a switching regulator allows for a large output voltage amplitude swing throughout the range of low vacuum settings and adjustments. The switching regulator can be supplied with 24V DC and still manage an output voltage amplitude as low as 1.225V DC without the worry of heat and power dissipation that might result from using a linear voltage regulator. By using the output of the PID circuit to directly control the output amplitude of the voltage regulator, any need for AD conversion by a processor and non-linear response can be eliminated, and the low vacuum control can be made a linear function. Low vacuum adjustments are almost instantaneous, responding to each jetting cycle, ink purges and high vacuum changes.

FIG. 4A shows an example of a processor implementation of defined set point, ramp, and DAC elements from the controller of FIG. 3A. These elements are implemented using a microprocessor 400, where code provided in firmware can define the set point based on print head orientation. FIG. 4B shows the output from the microprocessor of FIG. 4A in accordance with the defined set point in a chart 405. The set point (e.g., in mm water) is converted to digital value using a calculation determined using the voltage regulator circuit and vacuum sensor transfer functions. Once low vacuum control is enabled, or there is a change in the set point, the algorithm ramps to the new setpoint.

FIG. 4C shows an example of a ramping process to establish the set point. At initialization, the set point is ramped 450 to a value selected to maintain a negative pressure at a desired level. At run time, the set point is maintained 460 at a constant value (e.g., the selected value). During a purge cycle (which can be initiated either manually or automatically), the negative pressure is replaced 470 with a positive pressure using a set point change. This positive pressure can be employed to purge the system or evacuate debris from the faceplate of the print head. After the purge cycle, the set point is ramped 480 back to the value selected to maintain the negative pressure at the desired level. Note that multiple purges can be performed in sequence to push ink out the front end of the orifices in the jetting assembly (with the operator wiping the print head with a lint free wipe) to completely clean the jetting assembly and recover any jets that were not previously printing properly. This design can allow a greater purging pressure by applying a specific fixed maximum voltage to the pump for the purging operation. This voltage can be designed to ensure that the jets are being cleared during the purge cycle.

Furthermore, pump drive adjustment can be performed by a PID circuit with machine program code (software or firmware based) providing the vacuum set point via a machine user interface. The set point for the PID circuit can be the sole program code intervention in the voltage controlled circuit. This PID circuit can allow full linear adjustment, based on the feedback loop, as compared to previous approaches in which the control was accomplished by a software method using a PWM circuit. Comparatively, the PID approach can provide for a faster response time and settle time of the pump output after a purge function or ink fill cycle. With the software controlled PWM circuit, response time was often slow as the software would “search” for the proper vacuum level to settle on in an iterative and time consuming approach. Vacuum levels can still be monitored by a processor in implementations of the present invention, but adjustments need not be made by the program code based on the monitored readings.

FIG. 5 is a schematic diagram showing an example of a vacuum purge control assembly for a printing system. In this example, a pump P1 has an air vent 540 connected through a restriction R3. The pump P1 represents the low vacuum (LO-VAC) pump that provides an appropriate negative pressure to the print head. The LOW-VAC pump P1 is connected through an accumulator A2, a restriction R2, an accumulator A1, and a first filter 520 to a two-position valve 510 (e.g., a solenoid valve). In addition, an air intake 545 is connected through a second filter 530 and through a restriction R1 to the accumulator A1. Further, the second filter 530 is coupled with a second (PURGE) pump P2 to the two-position valve 510.

The first and second filters 520, 530 can each be 10 micron filters. The restrictions R1, R2, R3 can be flexible tubing, connected with accumulators A1, A2 as described further below. The restrictions R1, R2, R3 provide continuous passages of constant reduced cross-sectional area providing flow resistance proportional to their length and diameter, and can be constructed so as to avoid clogging. The restriction R2 is placed between the accumulators A1, A2 and typically set at a value designed to dampen pump oscillation to the print head. The restrictions R1 and R3 are typically set at values designed to get the LO-VAC pump P1 to run in its natural sweet spot over a variation of different settings for a given operation.

The LO-VAC pump P1 and the accumulators and restrictions are arranged so that a continuous flow of air is drawn through the filter 520 to provide substantially constant negative pressures (as specified) to the print head (e.g., via tubing to a reservoir or volume of ink, as described above, to which the low vacuum is applied). The positive pressure side of the pump P1 is connected to a line that opens to the atmosphere through the restriction R3 arranged to provide a constant positive air pressure (as specified) at the pump output line 540. A pressure sensor 550 is coupled with the vacuum purge control assembly for use in setting and maintaining the correct pressure level.

When it is necessary to purge the system to remove debris or air bubbles from the orifice passageways of the jetting assembly, the valve 510 is moved to a position connecting the positive pressure line from the PURGE pump P2 to the print head. After purging of any contaminants and air bubbles (which may have accumulated in the print head components) is completed, the valve 510 is restored to the position shown in FIG. 5, causing a negative pressure to be applied once again. Note that in various implementations, more than one valve, more than one output line, or both can be used to provide negative pressure and positive pressure (as needed) to various portions of the print head. For example, different negative pressures can be provided to the print head based on orientation of the print head, as described in U.S. Pat. No. 5,489,925 to Brooks et al. In addition, a line can be run from the pressure side of pump P1 through the valve 510 for use during a purge cycle, thus eliminating the need for the second pump P2.

FIG. 6A is a top view showing an example of an implementation of the vacuum purge control assembly of FIG. 5. This view shows detailed implementations of the LO-VAC pump and the PURGE pump (which can be identical pumps from the same manufacture, or different pumps), as well as a tube 610 to the print head, and tube 615 to the pressure sensor (e.g., on a circuit board holding the separate control electronics). FIG. 6B is a bottom view showing the example of the vacuum purge control assembly from FIG. 6A, including detailed implementations of accumulators A1, A2 and the restrictions R1, R2, R3. The restrictions R1, R2, R3 can be implemented using microbore tubing, as shown, which acts as a restrictor in the pneumatic circuit of the low vacuum control assembly. Restrictors are used to limit/govern the flow of the pump and to dampen resonance of diaphragm oscillation. Accumulator chambers A1, A2 add to total system volume, which lessens the impact of system variations.

FIG. 6C is an exploded bottom view showing the same example of the vacuum purge control assembly from FIG. 6B. As shown, the accumulators A1, A2 and the restrictions R1, R2, R3 are contained within a vacuum purge control (VPC) body 630 and sealed by a VPC seal 635 (e.g., a plate structure) that attaches thereto. The VPC body 630 and the VPC seal 635 can each be made of plastic or aluminum. The accumulators A1, A2 are machined out areas of the VPC body 630, and tubing 640 can be used to connect the restrictions R1, R2, R3 with the accumulators A1, A2. Note that other implementations can use different shapes for the VPC body and its seal (e.g., a block, a cylinder, etc.), and rather than being formed within the VPC body, the accumulators A1, A2 can also be formed in separate structures (e.g., a block, a cylinder, etc.) external to the VPC body.

The tubing 640 can be implemented using six silicone tubes, each having an inner diameter of one sixteenth of an inch and an outer diameter of three sixteenths of an inch, and each being 25 mm in length. The restrictions R1, R2, R3 can be implemented using three flexible tubes 650a, 650b, 650c. The flexible tubes 650 can be different lengths to control the restrictive values needed in a given application of the VPC assembly. For example, each of the tubes 650a, 650b can be 205 mm in length, whereas the tube 650c can be 610 mm in length. These flexible tubes 650 can be microbore tubing, such as Polyvinyl Chloride (PVC) tubing manufactured for medical and laboratory environments, where the tubing has a defined diameter (e.g., 0.040 inches in diameter) that is maintained within tight tolerance. For example, the PVC tubes can be cut from TYGON® PVC microbore tubing, available from Saint-Gobain Performance Plastics Corporation of Aurora, Ohio. This microbore tubing is available in a durometer that holds its shape well without kinking or collapsing. It can be coiled tightly to provide a compact package within the design. It is available in a range of sizes. It has a tightly controlled inner diameter, which will protect the design from process variations.

The combination of tubing bore times length will produce certain restrictive values. Various combinations of bore size(s) and length(s) work in the design. As it is often difficult to visually discern diameter differences, a single bore size of tube can be used to ease burden on manufacture. The bore size can be selected to produce the required range of desired outputs with a manageable length of tubing. The close tolerance of the tubing bore utilized opens up the required length tolerance to acceptable manufacturing limits.

Note that given the defined diameter of the tubing, this structure for the assembly allows one to cut the tubing to a desired length to obtain the desired restrictive result within the tolerances of the given application. In addition, this structure provides flexibility for future modifications. For example, if a later generation of the print head requires a different negative pressure with respect to the reservoir and jetting assembly (e.g., because of a changed reservoir design), the length of the tubing 650 can be readily changed by determining the new lengths, cutting new tubing to the new lengths, and replacing the old tubing with the new tubing in a simple pull-out-old and plug-in-new process.

The microbore tubing in this design acts as a replacement for the machined restrictors and orifice restrictors in the pneumatic circuit of previous low vacuum control assemblies. The use of microbore tubing can provide a more manufacturable solution and can provide a more robust solution when compared to the previous orifice restrictors, which are often prone to contamination failure. As will be apparent, the flexible tubing implementation of the restrictors can reduce contamination failure and also allows for replacement of the restrictors to be readily performed. In particular, use of microbore tubing, as described, can reduce system costs (due in part to the commercial availability of the tubing), improve resistance to particle contamination, improve chemical compatibility with ink, improve resistance to heat, an improve the ease of assembly.

FIG. 6D is an exploded top view showing the example of the vacuum purge control assembly from FIG. 6A. Tubes 620 and 622 are used to connect the LO-VAC pump and the PURGE pump, respectively, into the VPC body 630. The tube 615 can be coupled to a barb tee, one eighth inch fitting 665, which can in turn be coupled with a solenoid valve 660 through a twenty mm tube 624. Each of the tubes 610, 615, 620, 622, 624 can be implemented using silicone tubing having an inner diameter of three thirty seconds of an inch and an outer diameter of seven thirty seconds of an inch. In addition, the VPC assembly can include two inline filters 670, a connector screw terminal 680 (to provide connection for control of the LO-VAC pump, the PURGE pump, and the solenoid), and appropriate pan screws and cable ties to hold the components of the VPC assembly together.

Although the invention has been described herein with reference to specific embodiments, many modifications and variations therein will readily occur to those skilled in the art. Accordingly, all such variations and modifications are included within the intended scope of the invention.

What is claimed is:

1. A controller to maintain negative pressure in a print head of a printing system, the controller comprising:
control loop feedback logic to receive a set point and an output of a vacuum sensor associated with the print head;
a regulator coupled with an output of the feedback logic; and
a driver coupled with the regulator and configured to output a drive signal to a pump, which is associated with the print head, responsive to an output of the regulator.

2. The controller of claim 1, wherein the regulator comprises a voltage regulator, and the control loop feedback logic comprises proportional-integral-derivative (PID) circuitry.

3. The controller of claim 2, wherein the driver comprises:
a programmable logic device (PLD) to generate a pulse width modulated (PWM) signal; and
integrated circuitry coupled with the PLD to modulate the PWM signal, responsive to a motor drive voltage output of the voltage regulator, to generate the drive signal.

4. The controller of claim 3, wherein the PID circuitry comprises a closed loop circuit comprising exactly six operational amplifiers.

5. The controller of claim 3, wherein the PLD is configured to generate a sixty hertz square wave pulse.

6. The controller of claim 1, comprising a processor programmed to establish the set point by performing operations comprising:
ramping, at initialization, the set point to a value selected to maintain a negative pressure at a desired level;
maintaining, at run time, the set point at a constant value;
replacing, during a purge cycle, the negative pressure with a positive pressure using a set point change; and
ramping, after the purge cycle, the set point back to the value selected to maintain the negative pressure at the desired level.

7. A vacuum control assembly for a printing system, the assembly comprising:
a body having one or more associated accumulators;
a pump coupled with the body; and
one or more flexible tubes coupled with the one or more accumulators associated with the body and configured to restrict air flow within the vacuum control assembly.

8. The vacuum control assembly of claim 7, wherein the one or more flexible tubes comprise Polyvinyl Chloride (PVC) microbore tubing manufactured for medical and laboratory environments.

9. The vacuum control assembly of claim 7, wherein the one or more flexible tubes comprise multiple, fixed diameter tubes having tube lengths selected to produce target amounts of air flow restriction.

10. The vacuum control assembly of claim 7, wherein the body comprises a machined plate structure that forms the one or more associated accumulators therein.

11. A hot melt ink jet printing system comprising:
a jetting assembly having at least one ink reservoir;
a vacuum sensor associated with the at least one ink reservoir of the jetting assembly;
a vacuum control assembly coupled with the at least one ink reservoir of the jetting assembly, the vacuum control assembly comprising a pump; and
a controller coupled with the vacuum control assembly to maintain a negative pressure in the at least one ink reservoir of the jetting assembly;
wherein the controller comprises:
control loop feedback logic to receive a set point and an output of the vacuum sensor,
a regulator coupled with an output of the feedback logic, and
a driver coupled with the regulator and configured to output a drive signal to the pump responsive to an output of the regulator.

12. The hot melt ink jet printing system of claim 11, wherein the regulator comprises a voltage regulator, and the control loop feedback logic comprises proportional-integral-derivative (PID) circuitry.

13. The hot melt ink jet printing system of claim 12, wherein the driver comprises:
a programmable logic device (PLD) to generate a pulse width modulated (PWM) signal; and
integrated circuitry coupled with the PLD to modulate the PWM signal, responsive to a motor drive voltage output of the voltage regulator, to generate the drive signal.

14. The hot melt ink jet printing system of claim 13, wherein the PID circuitry comprises a closed loop circuit comprising exactly six operational amplifiers.

15. The hot melt ink jet printing system of claim 13, wherein the PLD is configured to generate a sixty hertz square wave pulse.

16. The hot melt ink jet printing system of claim 11, wherein the controller comprises means for establishing the set point by performing a ramping process.

17. The hot melt ink jet printing system of claim 11, wherein the vacuum control assembly comprises:
a body coupled with the pump and having one or more associated accumulators; and
one or more flexible tubes coupled with the one or more accumulators associated with the body and configured to restrict air flow within the vacuum control assembly.

18. The hot melt ink jet printing system of claim 17, wherein the one or more flexible tubes comprise Polyvinyl Chloride (PVC) microbore tubing manufactured for medical and laboratory environments.

19. The hot melt ink jet printing system of claim 17, wherein the one or more flexible tubes comprise multiple, fixed diameter tubes having tube lengths selected to produce target amounts of air flow restriction.

20. The hot melt ink jet printing system of claim 17, wherein the body comprises a machined plate structure that forms the one or more associated accumulators therein.
